(19) United States
(12) Patent Application Publication
(10) Pub. No.: US 2023/0259835 A1
(43) Pub. Date: Aug. 17, 2023

(54) SYSTEMS AND METHODS FOR FACILITATING TRAVEL

(71) Applicant: Rebook Inc., Boston, MA (US)

(72) Inventor: Timothy David Kasbe, Hauraki (NZ)

(21) Appl. No.: 18/079,150

(22) Filed: Dec. 12, 2022

Related U.S. Application Data
(60) Provisional application No. 63/309,698, filed on Feb. 14, 2022.

(51) Int. Cl. G06Q 10/02; G06N 5/022

(52) U.S. Cl. CPC G06Q 10/02; G06N 5/022

(57) ABSTRACT

Methods and apparatus for facilitating air travel are disclosed. The method includes determining, using first user travel data corresponding to a scheduled flight for a user, a departure delay for the scheduled flight, determining, based at least in part, on the departure delay for the scheduled flight, an alternate flight for the user, the determination being based, at least in part, on one or more of user location data, departure time information for the alternate flight, seat availability for the alternate flight, or an estimated time needed to reach an airport gate from which the alternate flight departs, and presenting, using a user interface, information corresponding to the alternate flight and a selectable user interface element to enable the user to book the alternate flight

### CROSS-REFERENCE TO RELATED APPLICATION

This application claims the benefit under 35 U.S.C. § 119(e) of U.S. Provisional Patent Application No. 63/309,698, filed Feb. 14, 2022, and entitled SYSTEMS AND METHODS FOR PREDICTING TRAVEL DISRUPTIONS AND RECOMMENDING REMEDIAL ACTIONS, the entire contents of which is incorporated herein by reference for all purposes.

### BACKGROUND

Travel, in particular airline travel, has become a major part of peoples' lives. Unfortunately, travelers can experience delays and cancellations due to various factors. Systems exist to inform a traveler of a delay and/or cancellation (e.g., arrival delay, departure delay, canceled flight, etc.). Most systems inform the traveler of such after a delay or cancellation is confirmed (e.g., by an airline), at which point the traveler may make alternative travel arrangements. Such changes to a traveler's plans can cause the traveler stress and anxiety, for example, while the traveler may be in the process of researching other available travel options and/or contacting (e.g., via phone, via an app, in-person support, etc.) travel support; moreover, in some cases, due to the travel disruption, the traveler may miss or be late for a scheduled event.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method for facilitating air travel may involve determining, using first user travel data corresponding to a scheduled flight for a user, a departure delay for the scheduled flight, determining, based at least in part, on the departure delay for the scheduled flight, an alternate flight for the user, the determination being based, at least in part, on one or more of user location data, departure time information for the alternate flight, seat availability for the alternate flight, or an estimated time needed to reach an airport gate from which the alternate flight departs, and presenting, using a user interface, information corresponding to the alternate flight and a selectable user interface element to enable the user to book the alternate flight.

In one aspect, the method may further involve receiving the first user travel data including at least one of a flight number, departure time information or a first departing airport, and processing, using a first machine learning model, at least the first user travel data to predict the departure delay for the scheduled flight, the first machine learning model being trained using at least one of historical information corresponding to the flight number or historical information corresponding to the first departing airport.

In another aspect, the method may further involve after receiving the first user travel data, receiving historical data corresponding to a plurality of airports, the historical data including at least one of departure delay information for respective airports or arrival delay information for respective airports, training the first machine learning model using the historical data, training a second machine learning model, different than the first machine learning model, using the historical data, determining first model performance data corresponding to the first machine learning model, determining second model performance data corresponding to the second machine learning model, and selecting, based at least in part on a comparison of the first model performance data and the second model performance data, the first machine learning model to process subsequent user travel data.

In another aspect, the method may further involve receiving first historical data corresponding to the first departing airport, the first historical data including at least one of departure delay information relating to a plurality of flights departing from the departing airport or arrival delay information relating to a plurality of flights arriving at the first departing airport, receiving historical weather data corresponding to a location of the first departing airport, training the first machine learning model using at least the first historical data and the historical weather data, training a second machine learning model, different than the first machine learning model, using at least the first historical data and the historical weather data, determining first model performance data corresponding to the first machine learning model, determining second model performance data corresponding to the second machine learning model, and selecting, based at least in part on a comparison of the first model performance data and the second model performance data, the first machine learning model to process subsequent user travel data.

In another aspect, the method may further involve receiving second user travel data corresponding to a flight departing from a second departing airport different from the first departing airport, and selecting a second machine learning model to predict a departure delay for the flight departing from the second departing airport, the selection being based on the second machine learning model being configured for the second departing airport.

In another aspect, the method may further involve determining an aircraft for the scheduled flight, determining one or more previous flights the aircraft is to complete, within a time period, before the flight, determining delay information for the one or more previous flights, and processing the delay information and the first user travel data using the first machine learning model to predict the departure delay.

In another aspect, the method may further involve in response to predicting the departure delay, presenting, using the user interface of the application, an indication that the scheduled flight is delayed, and presenting, using the user interface, a representation of one or more features causing the departure delay.

In another aspect, the method may further involve receiving airport data corresponding to a first departing airport for the scheduled flight, the airport data including at least one of airport traffic information or flight delay information, receiving weather data corresponding to the departure time information and a location of the first departing airport, the weather data including past hourly weather information and predicted future hourly weather information, receiving airline data corresponding to an airline providing the scheduled flight, the airline data including at least one of airline on-time departure information, airline on-time arrival information or crew schedule information, receiving event data corresponding to the departure time information, the event data including at least one of information related to one or more events occurring in the location of the first departing airport or national holiday information, processing, using a first machine learning model, the airport data, the weather data, the airline data, and the event data to generate model output data used to predict the departure delay, and processing, using a second machine learning model configured to identify a cause for the departure delay, the model output data to determine the one or more features causing the departure delay, wherein the one or more features include one or more of: the airport data, the weather data, the airline data or the event data.

In another aspect, the method may further involve receiving the user location data representing a current location of the user, determining, based on the user location data, one or more pre-boarding activities to be completed by the user prior to boarding the alternate flight, wherein the one or more pre-boarding activities include one or more of: travel to a departing airport of the alternate flight, parking at a departing airport of the alternate flight, flight check-in, baggage check-in, airport security or travel to the airport gate, and based in part on the determined pre-boarding activities, determining the estimated time needed to reach the airport gate for the alternate flight.

In another aspect, determining the estimated time may further involve receiving airport context data corresponding to the departing airport of the alternate flight and the departure time information for the alternate flight, wherein the airport context data includes at least one of an airport layout, traffic information for parking at the departing airport of the alternate flight, traffic information for curbside drop-off at the departing airport of the alternate flight, length of line at a check-in counter for an airline of the alternate flight, length of line at a baggage drop of the airline of the alternate flight, or an estimated length of time for airport security at the departing airport of the alternate flight, and determining the estimated time using the airport context data.

In another aspect, the method may further involve receiving aircraft maintenance data for an aircraft for the scheduled flight, the aircraft maintenance data including at least one of a date of recent maintenance work performed on the aircraft or previous equipment failure for the aircraft, and processing the aircraft maintenance data using the first machine learning model to predict the departure delay.

In another aspect, the method may further involve receiving pilot communication data corresponding to an aircraft for the scheduled flight, the pilot communication data representing one or more communications between a pilot of the aircraft and an airport traffic control tower, wherein the one or more communications occurred during a previous flight of the aircraft, and processing the pilot communication data using the first machine learning model to predict the departure delay.

In another aspect, the method may further involve predicting the departure delay before an airline of the scheduled flight identifies an actual delay of the scheduled flight, and in response to predicting the departure delay, presenting, using the user interface of the application, an indication that the scheduled flight is likely to be delayed.

In some disclosed embodiments, a system may comprise at least one processor, and at least one computer-readable medium encoded with instructions which, when executed by the at least one processor, cause the system to determine, using first user travel data corresponding to a scheduled flight for a user, a departure delay for the scheduled flight, determine, based at least in part, on the departure delay for the scheduled flight, an alternate flight for the user, the determination being based, at least in part, on one or more of user location data, departure time information for the alternate flight, seat availability for the alternate flight, or an estimated time needed to reach an airport gate from which the alternate flight departs, and present, using a user interface, information corresponding to the alternate flight and selectable user interface element to enable the user to book the alternate flight.

In one aspect, the computer-readable medium may be encoded with additional instructions which, when executed by the at least one processor, further cause the system to receive the first user travel data including at least one of a flight number, departure time information or a first departing airport, and process, using a first machine learning model, at least the first user travel data to predict the departure delay for the scheduled flight, the first machine learning model being trained using at least one of historical information corresponding to the flight number or historical information corresponding to the first departing airport.

In another aspect, the computer-readable medium may be encoded with additional instructions which, when executed by the at least one processor, further cause the system to receive historical data corresponding to a plurality of airports, the historical data including at least one of departure delay information for respective airports or arrival delay information for respective airports, train the first machine learning model using the historical data, train a second machine learning model, different than the first machine learning model, using the historical data, determine first model performance data corresponding to the first machine learning model, determine second model performance data corresponding to the second machine learning model, and select, based at least in part on a comparison of the first model performance data and the second model performance data, the first machine learning model to process subsequent user travel data.

In another aspect, the computer-readable medium may be encoded with additional instructions which, when executed by the at least one processor, further cause the system to receive first historical data corresponding to the first departing airport, the first historical data including at least one of departure delay information relating to a plurality of flights departing from the departing airport or arrival delay information relating to a plurality of flights arriving at the first departing airport, receive historical weather data corresponding to a location of the first departing airport, train the first machine learning model using at least the first historical data and the historical weather data, train a second machine learning model, different than the first machine learning model, using at least the first historical data and the historical weather data, determine first model performance data corresponding to the first machine learning model, determine second model performance data corresponding to the second machine learning model, and select, based at least in part on a comparison of the first model performance data and the second model performance data, the first machine learning model to process subsequent user travel data.

In another aspect, the computer-readable medium may be encoded with additional instructions which, when executed by the at least one processor, further cause the system to receive second user travel data corresponding to a flight departing from a second departing airport different from the first departing airport, and select a second machine learning model to predict a departure delay for the flight departing from the second departing airport, the selection being based on the second machine learning model being configured for the second departing airport.

In another aspect, the computer-readable medium may be encoded with additional instructions which, when executed by the at least one processor, further cause the system to in response to predicting the departure delay, present, using the user interface of the application, an indication that the scheduled flight is delayed, and present, using the user interface, a representation of one or more features causing the departure delay.

In some disclosed embodiments, at least one non-transitory, computer-readable medium may be encoded with instructions which, when executed by at least one processor included in a system, cause the system to determine, using first user travel data corresponding to a scheduled flight for a user, a departure delay for the scheduled flight, determine, based at least in part, on the departure delay for the scheduled flight, an alternate flight for the user, the determination being based, at least in part, on one or more of user location data, departure time information for the alternate flight, seat availability for the alternate flight, or an estimated time needed to reach an airport gate from which the alternate flight departs, and present, using a user interface, information corresponding to the alternate flight and a selectable user interface element to enable the user to book the alternate flight.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A shows an example implementation of a system for facilitating air travel, in accordance with some embodiments of the present disclosure;

FIG. 1B is a flowchart of an example routine that may be performed by the system illustrated in FIG. 1A, in accordance with some embodiments of the present disclosure;

FIG. 2 is a diagram of a network environment in which some embodiments of the systems and methods disclosed herein may be deployed;

FIG. 3 is a block diagram of a computing system that may be used to implement one or more of the components of the computing environment shown in FIG. 2 in accordance with some embodiments;

FIG. 4 is a block diagram illustrating example components of one or more computing systems, shown in FIG. 1A, for facilitating air travel;

FIG. 5 illustrates example data that may be processed by one or more computing systems shown in FIG. 1A for predicting air travel delay; and

FIG. 6 is a flowchart of an example routine that may be performed to configure one or more models of one or more computing systems, shown in FIG. 1A, for predicting air travel delay.

### DETAILED DESCRIPTION

For purposes of reading the description below of the various embodiments, the following descriptions of the sections of the specification and their respective contents may be helpful:

Section A provides an introduction to example embodiments of a system for predicting airline travel delay;

Section B describes a network environment which may be useful for practicing embodiments described herein;

Section C describes a computing system which may be useful for practicing embodiments described herein; and

Section D provides a more detailed description of example embodiments of the system for predicting airline travel delay introduced in Section A.

### A. Introduction to Illustrative Embodiments of a System for Facilitating Air Travel

Travelers can experience delays and/or cancellations in scheduled travel due to a number of factors. Systems configured to schedule travel (e.g., airline reservation systems) often inform a traveler of a delay/cancellation after it is confirmed (e.g., by the airline). Such notification may be too late for the traveler to efficiently reschedule or find alternative options for travel. Travel disruptions can cause a traveler stress and anxiety, may cause the traveler to miss events, may require the traveler to spend time waiting in an undesired location (e.g., airport, unfamiliar city, etc.) for the next travel option, etc. Although, the traveler may attempt to find alternative travel options, the traveler may not be aware all available or feasible options. For example, a flight to the traveler's desired destination may be scheduled to depart from the traveler's airport in 30 minutes, however, it may be impractical for the traveler to reach the gate in time to board the flight given the traveler's current location at the airport. The inventors of the present disclosure have appreciated and recognized that untimely reporting of travel delays and/or cancellations can cause stress, and can increase the travel delay experienced by a traveler.

The present disclosure relates to a system for facilitating air travel by predicting travel disruptions, such as delays and cancellations before they may occur and/or may be confirmed by an airport or an airline. The system may use one or more machine learning (ML) models to predict travel disruptions, where the ML model(s) may be configured using data (e.g., historical data) relating to, for example, an airport, an airline, particular flights/routes, weather, days of a week (e.g., weekday, weekend, Monday, etc.), and/or holidays/events. Some implementations may be configured to use additional data (e.g., pilot communications, aircraft maintenance records, previous flight leg delay information, etc.) to predict travel disruptions.

In some implementations, different types of ML models may be used for different airports (or airlines, geographic regions, etc.). For instance, a particular type of ML model may be better suited to analyze particular data patterns corresponding to a particular airport, and it may be better suited to predict travel disruptions at that airport. Some implementations may also involve selecting the type of ML model used to predict travel disruptions at different times of the year. For example, a first ML model type may be selected to predict travel disruptions for a first time period (e.g., for January), and a second ML model type may be selected to predict travel disruptions for a second time period (e.g., for February). Such selections of the ML model type may be based, for example, on a recent change/trend in data patterns.

In some embodiments of the present disclosure, the system may be configured to predict travel disruptions based on information about a traveler's currently scheduled travel and data corresponding to current situations, for example, current airport delays, current airline delays, current weather data, etc. In response to predicting a travel disruption, in some implementations, the system may also provide the traveler with alternate travel options (e.g., alternate flight options). Such alternate travel options may be determined based on information about the traveler's current situation and/or the likelihood of the traveler being able to successfully use the alternate travel option, for example, based on a traveler's current location, time to reach the boarding gate, time to clear airport security lines, etc. Some implementations may be configured to provide alternate travel options based on the traveler's preferences (e.g., aisle vs. window seat, first class options, morning departure time, etc.).

In some implementations, the system may be configured to determine a cause for the predicted travel disruption, and based thereon, may provide an explanation of such to a user of the system. For example, the system may be configured to use Explainable AI techniques, where humans can understand the decisions or predictions made by a ML model(s), to determine the cause of the travel disruption. In an example implementation, the system may use a ML model or other type of model (e.g., statistical models, probabilistic models, etc.), configured to perform Explainable AI techniques, to determine one or more factors contributing to the predicted travel disruption, for example, bad weather conditions, overall airport delays, holiday weekend, etc.

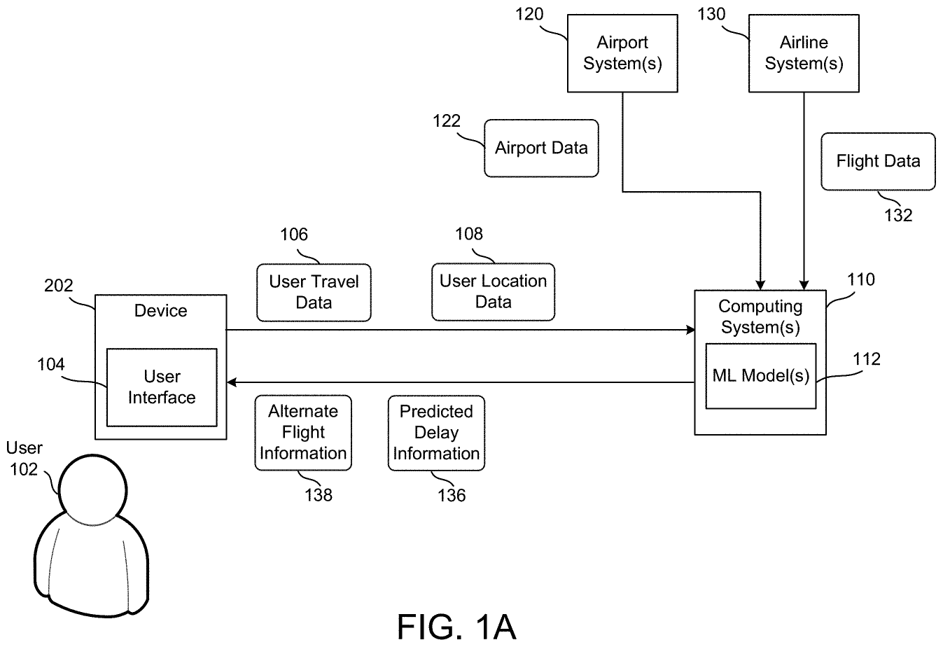

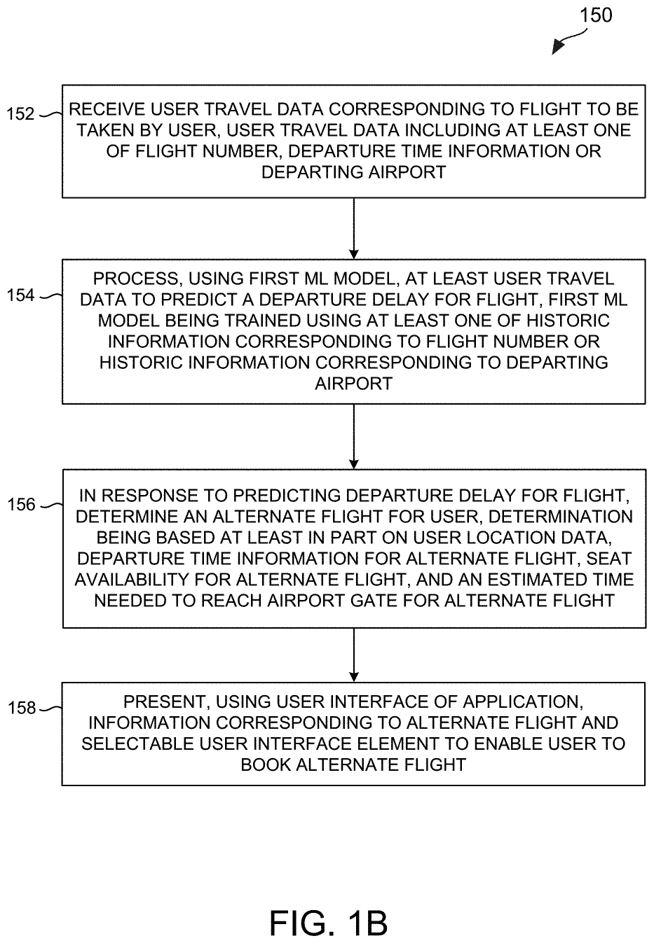

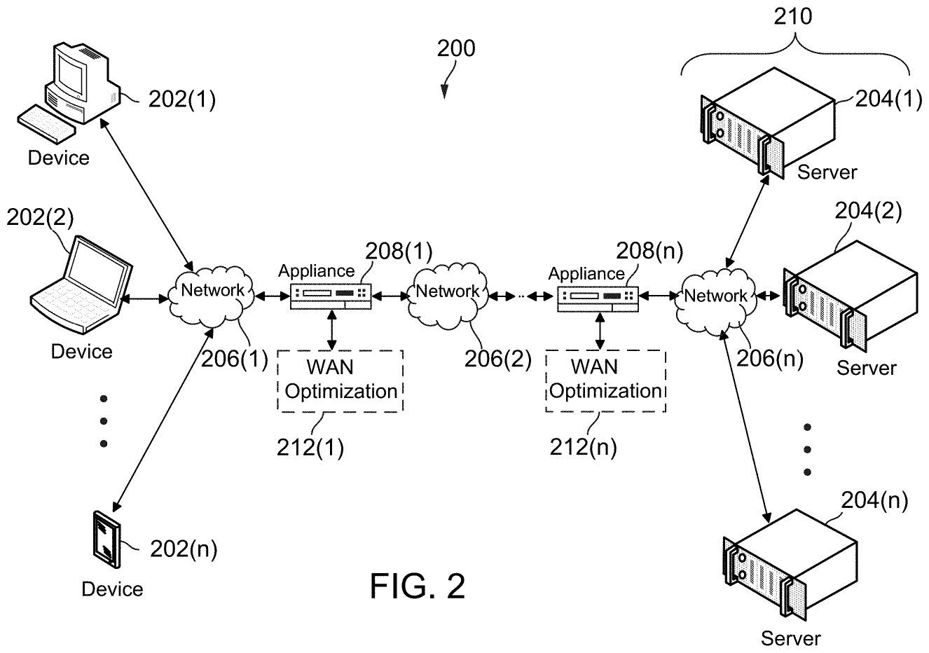

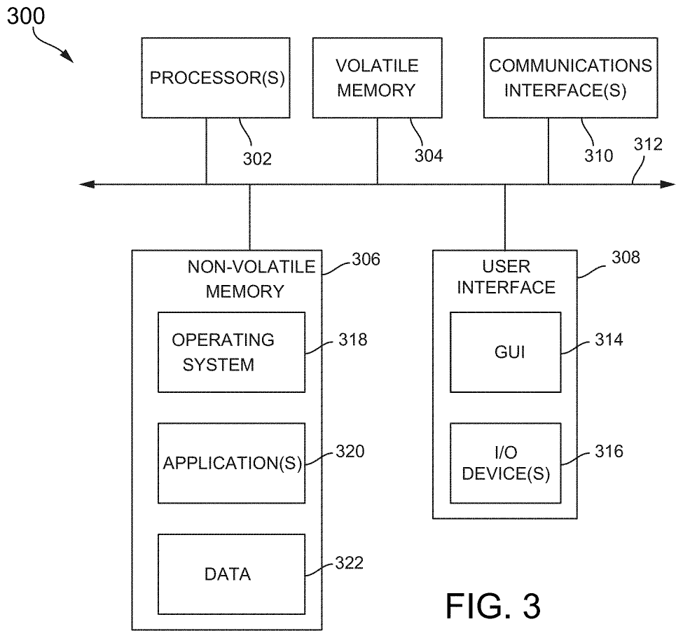

FIG. 1A shows an example configuration of a system architecture within which some aspects of the present disclosure may be implemented. One or more computing systems 110 may be configured to predict travel disruptions (e.g., delays, cancellations, etc.) and/or determine alternative travel information. As shown in FIG. 1A, the computing system(s) 110 may be arranged in communication with a device 202 operated by a user 102 and configured to present a user interface 104. The computing system(s) 110 may be arranged in communication with the device 202 via one or more networks 206 (shown in FIG. 2). The computing system(s) 110 may be implemented by one or more servers 204. The computing system(s) 110 may also be arranged in communication with one or more airport systems 120 and/or one or more airline systems 130 via the network(s) 206. The airport system(s) 120 and the airline system(s) 130 may be implemented by one or more servers 204. Examples of components that may be used to implement the device 202 and the servers 204, as well as examples of computing environments in which such components may be deployed, are described below in connection with FIGS. 2-3.

The airport system(s) 120 may provide airport data 122 including information related to one or more airports, such as flight arrival times, flight departure times, airport layout information, security wait times, check-in counter, parking information, airport curb traffic information, etc.

The airline system(s) 130 may provide flight data 132 including information related to one or more airlines, such as, flight numbers, flight arrival time, flight arriving airport, flight departure time, flight departing airport, flight length, flight route path, etc.

The device 202 may be configured to communicate user travel data 106 and user location data 108 to the computing system(s) 110. The user travel data 106 may be provided by the user 102 via the user interface 104, and may include flight information related to at least one flight that the user 102 is scheduled to take. The user travel data 106 may include, for example, a flight number, an airline name/code, a flight departure time and/or a departing airport name/code. Other information, such as, arrival airport name/code and arrival time may also be included in the user travel data 106. In some implementations, at least some of the flight information may be determined by the computing system(s) 110 based on the data included in the user travel data 106. For example, the user travel data 106 may include a flight number and a flight departure time, and the computing system(s) 110 may determine the airline name/code, the departing airport name/code, the arrival airport name/code, and/or the arrival time based on the flight number and the flight departure time included in the user travel data 106.

The user location data 108 may indicate a location of the user 102. For instance, the user location data may include Global Positioning Satellite (GPS) data captured by a sensor(s) of the device 202, location data entered by the user 102 via the user interface 104, or some other information describing the user's location. The computing system(s) 110 may use the user location data 108 to determine an alternate travel option(s) for the user 102.

The computing system(s) 110 may include, implement or otherwise use, one or more ML models 112. The ML model(s) 112 may be trained using historical data related to a particular airport and/or geographic location, and may be configured to predict a travel delay using various inputs, for example, the user travel data 106, the airport data 122 and the flight data 132. The user interface 104 may be provided by the computing system(s) 110 to facilitate interactions between the user 102 and the computing system(s) 110. In some implementations, the computing system(s) 110 may provide an application that the user 102 may access via the device 202. The application may be a native application installed at the device 202 or a web-based application that can be accessed via a web browser.

As described herein, the computing system(s) 110 may be configured to predict a travel disruption including, but not limited to, a delay/change in arrival and/or departure of a flight or a cancellation of a flight. In the example shown in FIG. 1A, the computing system(s) 110 may be configured to determine a travel delay for a flight indicated in the user travel data 106. Based on predicting a travel delay, the computing system(s) 110 may send predicted delay information 136 to the device 202. In some implementations, the computing system(s) 110 may determine one or more alternate travel options for the user 102. Based on determining the alternative travel options, the computing system(s) 110 may send alternate travel information (e.g., alternate flight information 138) to the device 202.

In some implementations, the computing system(s) 110 may perform an example routine 150, shown in FIG. 1B, to predict a departure delay for a flight for the user 102, and to determine an alternate flight for the user 102. At a step 152 of the routine 150, the computing system(s) 110 may receive the user travel data 106 corresponding to a flight to be taken by the user 102, wherein the user travel data 106 includes at least one of a flight number, departure time information or a departing airport. The information included in the user travel data 106 may be represented as text data or may be represented in the user travel data 106 in some other way (e.g., as audio data, numerical data, etc.). The user travel data 106 may be provided to computing system(s) 110 the day the flight is to depart, or may be provided prior the flight departure day, for example, a month before the scheduled flight, a week before the scheduled flight, at the time the user 102 books the flight, etc.

At a step 154 of the routine 150, the computing system(s) 110 may process, using a first ML model 112, at least the user travel data 106 to predict a departure delay for the flight. The first ML model 112 may be trained using historical information, examples of which include, but are not limited to, historical information specific to the flight number, historical information corresponding to the departing airport, or other historical data such as weather data, holiday data, airport data or airline performance data. The flight data 132, received from the airline system(s) 130, may include, for example, historical information for flights corresponding to the flight number and flight route. For example, the flight data 132 may include information that may be used to determine on-time performance of flights corresponding to the flight number and/or flight route. Such information may include, but is not limited to, information about prior flights' scheduled departure time, actual departure time, scheduled arrival time, and/or actual arrival time for the flight for a past number of days (e.g., the past 30 days, the past 3 months, the past year, etc.). The airport data 122, received from the airport system(s) 120, may correspond to the departing airport for the flight, and may include historical information for flights that departed from and/or arrived to the departing airport. For example, the airport data 122 may include scheduled departure times, actual departure times, scheduled arrival times, and/or actual arrival times for multiple different flights for a past number of days, thus, representing the airport's on-time performance over that time period. The first ML model 112 may be configured (e.g., trained, fine-tuned, etc.), using the airport data 122 and the flight data 132, prior to the computing system(s) 110 receiving the user travel data 106. In some implementations, other data may be used to configure the first ML model 112.

After configuration, the first ML model 112 may be used to predict a delay with respect to the flight represented in the user travel data 106. In doing so, the first ML model 112 may process the user travel data 106. In some implementations, the first ML model 112 may process additional data, such as, information for the departing airport for the flight departure day (e.g., other flight delays at the airport that day, number of scheduled flights, etc.), weather information for the flight departure day, information for the flight for the flight departure day (e.g., crew delays, prior flight leg delay, etc.), and/or other data. Based on processing the user travel data 106 (and other data), the first ML model 112 may predict that the flight departure will be delayed and/or canceled. The prediction may also include a likelihood that the flight will be delayed and/or canceled.

The computing system(s) 110 may send to the device 202, the predicted delay information 136 indicative of the departure delay, and may indicate a likelihood/probability of the flight being delayed (e.g., 80% chance of the flight being delayed, 20% chance of the flight being delayed, etc.). The predicted delay information 136 may be presented to the user 102 via the user interface 104.

At a step 156 of the routine 150, in response to predicting the departure delay for the flight, the computing system(s) 110 may determine one or more alternate travel plans (e.g., an alternate flight) for the user 102, where the determination may be based at least in part on the user location data 108, departure time information for the alternate flight, seat availability for the alternate flight, and estimated time needed to reach an airport gate for the alternate flight. The computing system(s) 110 may determine the estimated time needed to reach the airport gate for the alternate flight based on the user location data 108 and the departure time (or boarding time) for the alternate flight. In this manner, the computing system(s) 110 may determine an alternate flight that is feasible for the user 102 to board. For example, the user 102 may not yet be at the airport and may take longer to reach an airport gate for an alternate flight, in which case, the computing system(s) 110 may determine an alternate flight that departs after an estimated time needed for the user 102 to reach the airport gate (e.g., considering how long it will take the user 102 to get to the airport, how long it will take the user 102 to check a bag if needed, how long it will take the user 102 to clear airport security, etc.), which may be a few hours after the present time. As another example, the user 102 may be at the airport and may have cleared airport security already, in which case, the computing system(s) 110 may determine an alternate flight that departs after an estimated time needed for the user 102 to reach the airport gate for the alternate flight (e.g., take transportation from one airport terminal to another, walk to the gate, etc.), which may be a few minutes to an hour after the present time. The computing system(s) 110 may also consider other information in determining the alternate flight for the user 102. For example, the computing system(s) 110 may consider airline specific policies (e.g., bag check-in deadlines, modification/cancellation policies) and/or user preference policies (e.g., window seat availability, airline preference) for alternate flights when determining the alternative flight. In some implementations, the computing system(s) 110 may determine multiple different alternate flights.

The computing system(s) 110 may send to the device 202, the alternate flight information 138 indicative of the determined alternate flight(s) (e.g., flight number, airline, departure time, arrival time, etc.). At a step 158 of the routine 150, the computing system(s) 110 may present, using the user interface 104, the alternate flight information 138, and a selectable user interface element to enable the user 102 to book the alternate flight (or select from multiple alternate flight options). Selection of the user interface element may cause one or more operations to be performed to book the alternate flight, where such operations may be performed via the computing system(s) 110 in conjunction with the airline system(s) 130 (or another system configured to book airline travel).

Additional details and example implementations of embodiments of the present disclosure are set forth below in Section D, following a description of example systems and network environments in which such embodiments may be deployed.

### B. Network Environment

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the networks 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one of more appliances 208 may operate as an application delivery controller (ADC) to provide one or more of the clients 202 with access to applications and other data deployed in a datacenter, the cloud, or delivered as Software as a Service (SaaS) across a range of client devices, and/or provide other functionality such as load balancing, etc.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some implementations, one or more of the appliances 208, 212 may be cloud connectors that enable communications to be exchanged between resources within a cloud computing environment and resources outside such an environment, e.g., resources hosted within a data center of an organization.

### C. Computing Environment

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Detailed Description of Example Embodiments of the System for Facilitating Air Travel Introduced in Section A

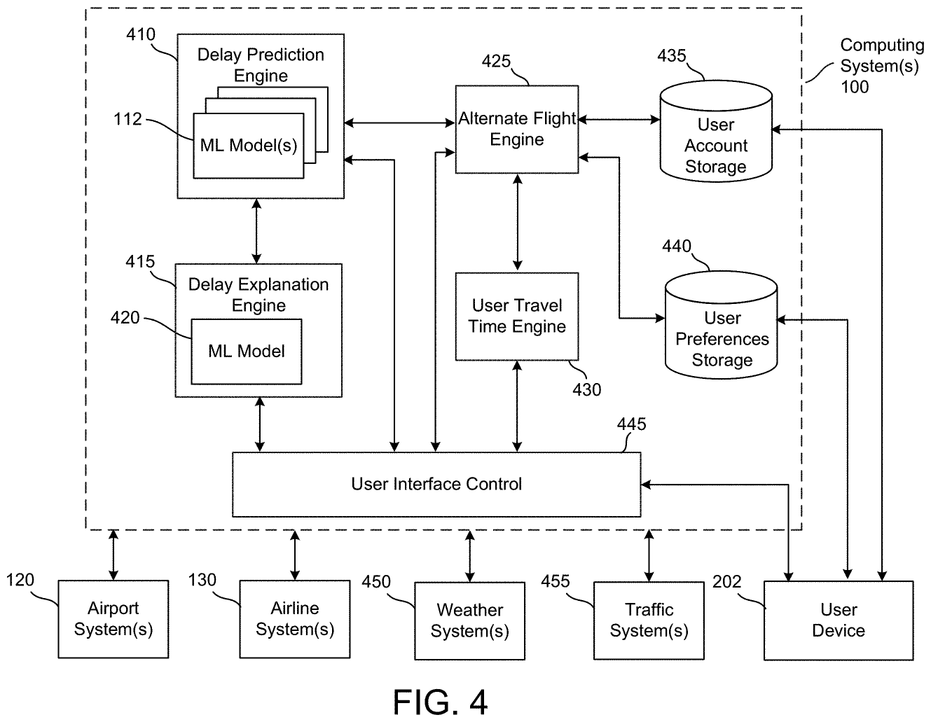

As described in Section A above, the present disclosure relates to techniques for facilitating air travel by predicting travel delays and determining alternate travel options. FIG. 4 is a block diagram illustrating example components that may be used to implement one or more of the functionalities described herein. As shown in FIG. 4, in some implementations, the computing system(s) 100 may include a delay prediction engine 410, a delay explanation engine 415, an alternative flight engine 425, a user interface control 445, a user account storage 435 and a user preferences storage 440. The computing system(s) 100 may be in communication with (or may include) the airport system(s) 120, the airline system(s) 130, one or more weather system(s) 450, and one or more traffic system(s) 455. The computing system(s) 100 may also be in communication with the device 202. Other implementations may include different configurations of the components shown in FIG. 4 as described below.

In some implementations, the computing system(s) 100 may include one or more processors (e.g., processors 302 shown in FIG. 3) as well as one or more computer-readable mediums (e.g., volatile memory 304 and non-volatile memory 306 shown in FIG. 3) that are encoded with instructions to be executed by the processor(s). In some implementations, such instructions may cause the processor(s) to implement one or more, or possibly all, of the operations of the computing system(s) 100 described herein. The components shown in FIG. 4 may be in direct or indirect communications via network(s) 206 (shown in FIG. 2).

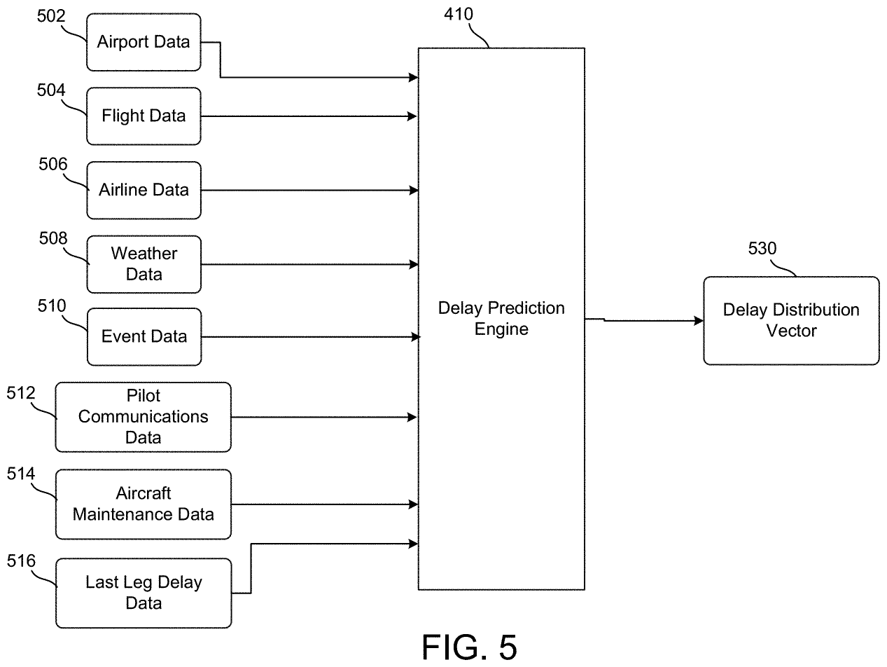

As described above in Section A, the computing system(s) 100 may implement the ML model(s) 112. In some implementations, as shown in FIG. 4, the ML model(s) 112 may be included in the delay prediction engine 410. The delay prediction engine 410 may be configured to process various types of data to determine or predict (e.g., with an associated likelihood/probability) a delay (which includes a cancellation, a reschedule, etc.) in a flight departure and/or a flight arrival. Further details describing examples of the types of data that may be processed by the delay prediction engine 410 are provided below and shown in FIG. 5.

As shown in FIG. 5, the delay prediction engine 410 may receive and process various types of data, such as airport data 502, flight data 504, airline data 506, weather data 508, event data 510, pilot communications data 512, aircraft maintenance data 514, and last leg delay data 516. The foregoing data may correspond to the flight(s) indicated in the user travel data 106 (shown in FIG. 1). For example, the airport data 502 may include information related to the departing airport for the flight that the user 102 is scheduled to take. As another example, the weather data 508 may include weather information for the departing airport and/or the arriving airport for the flight that the user 102 is scheduled to take. In other embodiments, the delay prediction engine 410 may receive and process other types of data.

The user travel data 106 may include information related to multiple different travel plans for the user 102. In cases where a travel plan of the user 102 involves a direct flight, the user travel data 106 may include information for that one flight associated with the travel plan. In cases where a travel plan involves layovers/stopovers, the user travel data 106 may include information for multiple flights associated with the travel plan. In some embodiments, the user travel data 106 may include information related to other types of travel modes, such as bus, train, boat, etc. In some embodiments, the user travel data 106 may include hotel information, car rental information, etc. when the user 102 has made such reservations as part of a travel plan.

The airport data 502 may include information related to a departing airport that the flight(s) departs from and/or an arrival airport at which the flight(s) lands. In cases, where the user 102 is scheduled for a direct flight (e.g., the arrival airport may be the user's travel destination), the airport data 502 may include information for two airports (e.g., the departure airport and the arrival airport). In cases, where the user's travel plan involves one or more layovers, the airport data 502 may include information for the departing airport, the arrival/travel destination airport, and the layover airport(s) where the layover(s) occurs.

For each individual airport, the airport data 502 may include information such as a number (or percentage) of flights departing on-time (e.g., at the scheduled time or before the scheduled time) from the airport, a number (or percentage) of flights with delayed departures (e.g., after the scheduled time) from the airport, airport traffic/congestion metrics (which may be based on the number of flights scheduled for departure and arrival at a certain time period, a number of gates available, a number of planes that can take-off/land at a time, etc.), and/or other issues or events associated with the airport that may affect the airport's functions (e.g., events that may cause closing of a gate(s) or terminal(s) of the airport, employee shortage, change in operation hours, etc.). The airport data 502 may include other types of information. In some implementations, different types of information may be associated with different airports. For instance, a first airport may have detailed information about airline staffing that a second airport may not have.

The flight data 504 may include information related to one or more flights of a travel plan (e.g., one flight when the user 102 is taking a direct flight; multiple flights when the user 102 has layovers). For the individual flights, the flight data 504 may include historical flight performance metrics, which may be associated with a same flight number, for a certain time period (e.g., past twenty-four hours, past week, past month, past year, etc.). For example, an airline may assign a flight number to a flight route originating at a particular departure airport, ending at a particular arrival airport and occurring at a particular time on a periodic basis (e.g., daily, weekly, monthly, etc.). Using the flight number, historical information related to flights may be derived, such as, on-time departure, on-time arrival, delayed departure, delayed arrival, etc., and the foregoing may be referred to as the historical flight performance metrics. The flight data 504 may also include other contextual information related to the flight, which may have impacted the flight's performance (e.g., airport issues, crew issues, holidays, events, etc.).

The flight data 504 may also include for each of the individual flights in a travel plan, information about the flight itself, examples of which include, but are not limited to, departing time, arrival time, flight length, time the flight is arriving at the departing airport (e.g., after completion of any prior flight route(s)), type of aircraft, number of seats, number of passengers booked for the flight, crew information (e.g., crew arrival time from another flight, adequate crew support, etc.), and the like.

The weather data 508 may include weather information for the airports indicated in the airport data, for example, the departing airport, the arrival airport, and/or the layover airport(s). The weather data 508 may include daily weather, hourly weather, and/or weather alerts (e.g., for bad weather) for a certain time period with respect to the departure time and the arrival time of the flight. For example, the weather data 508 may include weather information, for a geographic location (e.g., city, state, country, etc.) of the departing airport, for twenty-four hours prior to flight departure time and twenty-four hours after flight departure time. As another example, the weather data 508 may include weather information, for a geographic location of the arrival airport, for twenty-four hours prior to flight arrival time and twenty-four hours after flight arrival time.

The event data 510 may include information related to various events that may be occurring at the time of the flight, in a location of the departing airport and/or a location of the arrival airport. Examples of such events include public/national holidays (e.g., Christmas, Thanksgiving, other holidays, etc.), sporting events (e.g., Semi-final games, Championship games, etc.), concerts, state-specific events, city-specific events, other major publicized events, etc. The event data 510 may include information related to events that may affect an airport's functioning, for example, employee strike, political crisis, etc.

The pilot communications data 512 may include information related to communications between a pilot(s) of the flight and an airport traffic control tower. Such communications may occur during a prior flight leg, past flight, when the plane is landing at the departing airport, etc. The pilot communications data 512 may indicate one or more issues that may cause a travel delay. For example, the pilot may indicate to the airport traffic control tower that additional maintenance is needed on the aircraft prior to departure, which may cause the user's flight to be delayed. The pilot communications data 512 may be a transcript of the communications between the pilot and the airport traffic control tower. In other embodiments, the pilot communications data 512 may include codes or other abbreviations indicative of what the pilot or the airport control traffic room communicated. In other embodiments, the pilot communications data 512 may include communications between other crew members and the cockpit, other crew members and the airport traffic control tower, etc.

In some embodiments, the pilot communications data 512 may include features derived from an audio recording of the communications between the pilot and the airport traffic control tower. Such features may be derived using audio and/or voice analysis techniques, and may include speech patterns, prosody, tone, pitch, emotion/sentiment (e.g., stressed, calm, neutral, angry, happy, sad, etc.), etc.

The aircraft maintenance data 514 may include information related to an aircraft(s) to be used for the flight(s) in a travel plan, where the information may be associated with an aircraft identifier, an aircraft name, and/or an aircraft type. For the individual aircrafts, the aircraft maintenance data 514 may include information such as last time maintenance was performed on the aircraft, results of the most recently performed maintenance, condition of aircraft parts (e.g., new, at half-life, needs replacement, etc.), historic functioning of the aircraft, previous equipment failure, historic maintenance records, etc. Certain aircraft conditions, for example, old parts, malfunctioning in certain weather, malfunctioning after a number of flight routes, etc., may cause travel delays, and the aircraft maintenance data 514 may be used to identify/predict such conditions for a user's scheduled flight.

The last leg delay data 516 may correspond to delays that may have occurred or are likely to occur to one or more prior flight legs/routes of the aircraft associated with the user's scheduled flight. The aircraft may be identified using a tail number or other identifying information. In some embodiments, the last leg delay data 516 may be a linked list indicative of the prior flight legs. In some embodiments, the computing system(s) 110 may determine the linked list using flight data available from the airline system(s) 130, the airport system(s) 120, or other systems. For instance, the linked list may be determined using the tail number and the departing airport of prior flight legs.

A linked list is a linear organization of nodes in which the node order may not be represented by their physical placement in the memory; instead, each node is associated with a pointer to the next node. For illustrations, consider airports A, B and C, and an aircraft with the tail number “1234”. The aircraft “1234” may operate as flight number F123 from airport A to airport B, and the same aircraft “1234” may operate as flight number F124 from airport B to airport C.

To predict if there will be any departure delay for the flight F124 from airport B to airport C, the delay prediction engine 410 may determine if the last/prior leg of the aircraft (with flight number F123 from airport A to airport B) departed on time from airport A. This delay may be referred to as last leg delay. In some cases, if the last leg was delayed, the delay prediction engine 410 may determine that the leg of the travel route on which the user is scheduled to travel is likely to be delayed, depending on how delayed last leg was. If more than one last leg was delayed, then the delay prediction engine 410 may determine that the leg of the travel route on which the user is scheduled to travel is also likely to be delayed.

The data available at certain systems (e.g., the airline system(s) 130, the airport system(s) 120, etc.) may not have the last leg delay information for an aircraft. The computing system(s) 110 may determine the last leg delay by organizing the data in a linked list form. The linked list may contain two or more nodes, and each node may include a data element and a pointer to the next node. The data element of the node may indicate whether or not the associated flight is delayed. The data element may be text data, a Boolean value, etc. The pointer to the next node may indicate the flight number of the next flight in a travel route for the aircraft. For example, a first node corresponding to a first leg may be {data element=“delayed: Yes”; pointer=“F124”}, and a second node corresponding to a following second leg may be {data element=“delayed: Yes”; pointer=“F435”}. In some embodiments, separate linked lists may be generated for individual tail numbers for a time frame (e.g., twenty-four hours, forty-eight hours, etc.).

In some embodiments, the various types of data shown in FIG. 5 and described herein may be processed by one or more encoders (included in the delay prediction engine 410) to generate corresponding embedding data, and the embedding data may be processed by the ML model(s) 112.

The delay prediction engine 410 may process, using the ML model(s) 112, the types of data shown in FIG. 5 (or embeddings based on the types of data) to predict a travel delay. The delay prediction engine 410 may also determine a probability/likelihood of the travel delay occurring (e.g., 20% likely flight departure is delayed, 80% likely the flight departure is delayed, 60% likely the flight arrival is delayed, etc.). The delay prediction engine 410 may output a delay distribution vector 530 based on processing the various types of data, where the delay distribution vector 530 may be a vector of values, where individual values in the vector correspond to individual types of data processed by the delay prediction engine 410. The individual values may represent a probability of the corresponding type of data contributing to a travel delay. For example, the delay distribution vector 530 may be {airport data: 0.1; flight data: 0.1; airline data: 0.0; weather data: 0.6; event data: 0.6, pilot communications data: 0.2; aircraft maintenance data: 0.1; last leg delay data: 0.3}. In this example, there is a 0.6 (or 60%) probability that the weather information included in the weather data 508 will cause a travel delay; likewise, there is a 0.6 (or 60%) probability that the event information included in the event data 510 will cause a travel delay; and so on. The output of the delay prediction engine 410 may be included in the predicted delay information 136 (shown in FIG. 1) sent to the device 202.

The values of the delay distribution vector 530 may be output by the ML model(s) 112. In some embodiments, separate ML models 112 may be configured to process different types of data. For example, a first ML model 112a may be configured to process the airport data 502, a second ML model 112b may be configured to process the flight data 504, and so on. In other embodiments, a ML model 112 may be configured to process more than one type of data. For example, a first ML model 112a may be configured to process the airport data 502, the flight data 504 and the airline data 506, and a second ML model 112b may be configured to process the weather data 508 and the event data 510, and so on. The probability values output by the individual ML models 112 may be included in the delay distribution vector 530.

In some embodiments, outputs of one or more of the ML model(s) 112 may be weighted prior to being included in the delay distribution vector 530, such certain types of data (e.g., the weather data 508) may have a higher impact on predicting a travel delay than other types of data (e.g., aircraft maintenance data 514).

In some embodiments, the delay distribution vector 530 may correspond to a single flight. In such embodiments, where a travel plan involves one or more layovers (i.e., the flight is not the only flight in the traveler's travel plan), the delay prediction engine 410 may determine individual delay distribution vectors 530 for each of the flights in the traveler's travel plan. In this manner, the delay prediction engine 410 may determine that a particular flight of the travel plan (e.g., the second flight departing from a layover) is likely to be delayed even though another flight of the travel plan (e.g., the first flight of the travel plan) is likely to be on time.

The types of data shown in FIG. 5 may be received by the computing system(s) 110 from various other systems, examples of which are shown in FIG. 4. In some embodiments, the airport system(s) 120 may provide the airport data 502 and the pilot communications data 512; the airline system(s) 130 may provide the flight data 504, the airline data 506, the aircraft maintenance data 514 and the last leg delay data 516; and a weather system(s) 450 may provide the weather data 508. The event data 510 may be retrieved from other systems/sources such as the Internet. The weather system(s) 450 may be implemented by one or more servers 204.

Explainable AI is a combination of frameworks and tools to help end users understand and digest the predictions made by machine learning models. Various types of existing explainable AI packages may be used to understand delay predictions determined in accordance with the techniques described herein. For example, SHAP (SHapley Additive exPlanations) is a game theory based model that may be used to interpret the delay predictions. As another example, LIME (Local interpretable model agnostic explanations) may alternatively be used to explain the delay predictions. Other packages including, but not limited to, Shapash, ExplainerDashboard and Dalex may additionally or alternatively be used to interpret the delay predictions. Referring now to FIG. 4, the delay explanation engine 415 may be configured to determine an explanation (e.g., a reason, a contributing factor, etc.) for the delay. The explanation may help the user find the reason(s) for a delay or no delay. The explanation may be included in the predicted delay information 136 (shown in FIG. 1) sent to the device 202. The delay explanation engine 415 may implement a ML model 420 and may process various data to determine the explanation. In some embodiments, the delay explanation engine 415 may employ one or more Explainable Artificial Intelligence (AI) techniques, which may aid users in understanding the decisions or predictions made by a ML model (in this case, the ML model(s) 112). In an example implementation, the delay explanation engine 415 may receive prediction data (e.g., the delay distribution vector 530) from the delay prediction engine 410. The delay explanation engine 415 may also (or alternatively) receive one or more of the various inputs (shown in FIG. 5) provided to the delay prediction engine 410. In other implementations, the delay explanation engine 415 may also (or alternatively) receive model data from the delay prediction engine 410, where the model data may include data generated by the ML model(s) 112 in response to processing the various input data shown in FIG. 5. Examples of the model data may be layer/node parameters, layer/node weights, model output prior to softmax (or other layers) being applied, etc.

In some embodiments, the ML model 420 may be configured (pre-trained, trained, fine-tuned, re-trained, etc.) using one or more of the types of data that may be provided to the ML model(s) 112. In some embodiments, the ML model 420 may be trained using samples of data provided as input to the ML model(s) 112 and the corresponding prediction output by the ML model(s) 112. As such, the ML model 420 may be trained to learn a correlation between the inputs and the prediction, and may determine which one (or more) of the inputs is a reason for the predicted delay. In some embodiments, the ML model 420 of the delay explanation engine 415 may be configured (e.g., pre-trained, trained, fine-tuned, re-trained, etc.) in conjunction with the ML model(s) 112, so that the ML model 420 may learn how the ML model(s) 112 determines its predictions.

In some embodiments, the delay explanation engine 415 may determine the explanation based on the probability values included in the delay distribution vector 530. For example, the delay distribution vector 530 may be {airport data: 0.1; flight data: 0.1; airline data: 0.0; weather data: 0.6; event data: 0.6, pilot communications data: 0.2; aircraft maintenance data: 0.1; last leg delay data: 0.3}, and the delay explanation engine 415 may determine that weather information and event information are the likely cause of the travel delay based on the probabilities corresponding to the weather data and the event data.

In some embodiments, the delay explanation engine 415 may determine particular information within the type of data that is the likely cause of the travel delay. For example, the delay explanation engine 415 may determine that a particular weather condition (e.g., thunderstorms, tornado, extreme heat, etc.) is the likely cause of the travel delay. Such determination may be made by processing the weather data 508 provided as input to the delay prediction engine 410, and/or model data generated by the delay prediction engine 410 in processing the weather data 508. As another example, the delay explanation engine 415 may determine that a particular airport condition (e.g., airport congestion, terminal/gates being out of service, etc.) is the likely cause of the travel delay.

In cases where the user 102 has layovers, the delay explanation engine 415 may also determine which flight leg of a travel plan is the cause (or the primary cause) of the overall travel delay.

The alternate flight engine 425 (shown in FIG. 4) may be configured to identify one or more alternate travel options in response to predicting a travel delay in the user's original travel plan. In some embodiments, the alternate flight engine 425 may receive the delay distribution vector 530 from the delay prediction engine 410. In other embodiments, the delay prediction engine 410 may send an indication that a travel delay is predicted and data identifying the flight that is predicted to be delayed. The identified alternate travel option(s) may be included in the alternate flight information 138 (shown in FIG. 1) sent to the device 202.

In some embodiments, the alternate flight engine 425 may identify an alternate flight option(s) based on the user location data 108 and an estimated time that the user needs to reach an airport gate for an alternate flight. The alternate flight engine 425 may further identify the alternate flight option(s) based the departure time information for the alternate flight and seat availability for the alternate flight. In some embodiments, the alternate flight engine 425 may further identify the alternate flight option(s) based on user preferences for the user 102 and stored at the user preferences storage 440.

In some embodiments, the user travel time engine 430 may determine the estimated time that the user needs to reach an airport gate for an alternate flight (referred to herein as “the estimated user travel time”), and may send the estimated user travel time to the alternate flight engine 425. The user travel time engine 430 may receive the user location data 108, which may be provided by the device 202 via the user interface control 445. The user location data 108 may indicate a current location of the user 102, and may be, for example, GPS data captured by a sensor(s) of the device 202, location data entered by the user 102, or may be derived in another manner.

The user travel time engine 430 may also receive other data, such as traffic data corresponding to the current user location and the location of the departing airport for the alternate flight. The traffic data may be provided by the traffic system(s) 455, which may be implemented as one or more servers 204. In some implementations, the user travel time engine 430 may use the traffic data to determine the estimated user travel time when the user 102 is not yet at the departing airport for the alternate flight (e.g., the user 102 is at home, the user 102 is at work, the user 102 is at another airport, etc.). For example, the user travel time engine 430 may use the traffic data to determine how long it would take the user 102 to navigate from the user's current location (included in the user location data 108) to the alternate flight's boarding gate.

The user travel time engine 430 may receive airport layout/map information from, for example, the airport system(s) 120. In some implementations, the user travel time engine 430 may use the airport layout information to determine the estimated user travel time when the user 102 is at the departing airport for the alternate flight. For example, the user travel time engine 420 may use the airport layout information to determine how long it would take the user 102 to navigate to the alternate flight's boarding gate from the user's current location within the airport. As another example, the user travel time engine 420 may use the airport layout information to determine how long it would take the user 102 to navigate from a particular location within the airport (e.g., check-in area/counters, security line exit, etc.) to the alternate flight's boarding gate.

In determining the estimated user travel time, in some embodiments, the user travel time engine 430 may also consider the time it would take the user 102 to perform various pre-boarding activities at the departing airport for the alternate flight. Such pre-boarding activities may involve traveling to the airport, parking a vehicle at/near the airport, flight check-in at an airline counter, baggage check-in, clearing airport security, traveling to the flight boarding gate, etc. The estimated user travel time may be based on how long it may take the user 102 to navigate (e.g., walk, ride a shuttle, etc.) from a parking area to the check-in counters at the airport. The estimated user travel time may also be based on how long it may take the user 102 to complete check-in (e.g., number of persons in line at the check-in counter, number of check-in counters open, etc.). The estimated user travel time may also be based on how long it would take the user 102 to travel through airport security (e.g., number of persons in line for security, number of security counters open, whether the user has expedited security credentials, etc.). The user travel time engine 430 may use airport context data provided by the airport system(s) 120 to determine some or all of the foregoing information, where the airport context data may include the airport layout information, traffic information for parking at the airport, traffic information for curbside drop-off at the airport, length of line at a check-in counter for an airline of the alternative flight, length of line at a baggage drop of the airline of the alternative flight, an estimated length of time for airport security, and the like.

The user travel time engine 430 may determine estimated user travel times for each of multiple individual alternate flight options, which may be communicated by the alternate flight engine 425.

The alternate flight engine 425 may identify alternate flight options based on the feasibility of the user 102 reaching the boarding gate prior to the departure time of the alternate flight. For example, based on the estimated user travel time, the alternate flight engine 425 may not identify a flight as a feasible alternate flight if the user cannot reach the boarding gate in time (e.g., at least 15 minutes before a scheduled departure of the flight).

In some embodiments, the alternate flight engine 425 may rank alternate flight options based, at least in part, on how much time the user may need to reach the boarding gate of the respective alternate flight. For example, alternate flight options that require less time to travel to may be ranked higher (e.g., when the user prefers a shorter travel time).

The alternate flight engine 425 may also (or instead) rank alternate flight options based on other factors. In example embodiments, the alternate flight options may be ranked based on respective flight departure times (e.g., flights departing sooner may be ranked higher than flights departing later). In further example embodiments, the alternate flight options may be ranked based on a predicted delay for the alternate flight option, where the predicted delay may be determined by the computing system(s) 110 using one or more of the techniques as described herein. In yet further example embodiments, the alternate flight options may be ranked based on user preferences of the user 102, where flights matching user preferences may be ranked higher than flights that do not match user preferences.

The user 102 may provide inputs, via the device 202, indicative of one or more user preferences with respect to travel options, and the user preferences may be stored in the user preferences storage 440. The user preferences may relate to air travel preferences, for example, a departure time preference (e.g., morning departure time, afternoon departure time, evening departure time, etc.), arrival time preference (e.g., morning arrival time, afternoon arrival time, evening arrival time, etc.), seating class (e.g., first class, business class, economy, etc.), seat preference (e.g., window seat, aisle seat, emergency row, etc.), meal/food preference (e.g., non-vegetarian, vegetarian, gluten-free, etc.), airline preference, payment preference (e.g., credit card, rewards points, mileage points, etc.), baggage check-in preference (e.g., carry-on only, baggage check-in, etc.), layover preference (e.g., direct flight, one layover, more than one layover, etc.), travel duration, minimum and/or maximum travel/flight cost, ticket policy (e.g., refundable, non-refundable, etc.) and the like.

In other embodiments, the user preferences may relate to other information that may be used to make accommodations during travel delays, for example, hotel preference, car service preference, restaurant/dining preference, etc.

As described above, the delay prediction engine 410 may predict that a flight is likely to be delayed, the delay explanation engine 415 may determine a cause for the delay, and the alternate flight engine 425 may determine one or more alternate flight options. The foregoing determined information may be communicated to the user interface control 445, which in turn may present in indication of the information to the user 102 via the device 202. The user interface control 445 may be configured to work in conjunction with the user interface 104 (shown in FIG. 1), and may route user inputs received via the user interface 104 to other components of the computing system(s) 110, may cause output of information via the user interface 104, etc.

In some embodiments, the user interface control 445 may cause (directly or indirectly) the device 202, via the user interface 104, to present a selectable user interface element (e.g., a button) corresponding to an alternate flight option. The user interface 104 may present a selectable user interface element corresponding to individual alternate flight options, when multiple alternate flight options are presented. The user 102 may provide a user input selecting the selectable user interface element to book the corresponding alternate flight option.

The user input indicative of a request to book the alternate flight option may be received by the user interface control 445, which in turn may route the user input to the alternate flight engine 425. The alternate flight engine 425 may perform one or more operations that books the user 102 on the alternate flight. In some embodiments, the alternate flight engine 425 may use data stored in the user account storage 435 for the user 102 to book the alternate flight option. The user account storage 435 may store information such as a name of the user 102, user contact information, payment information, rewards/loyalty program number, and the like. In some embodiments, the user account storage 435 may also store images (or other type of data) of identification(s) (e.g., driver's license, passport, etc.) of the user 102, which may be used to book a flight or to perform other functions related to air travel. In booking the flight, the alternate flight engine 425 may communicate with the airline system(s) 130.

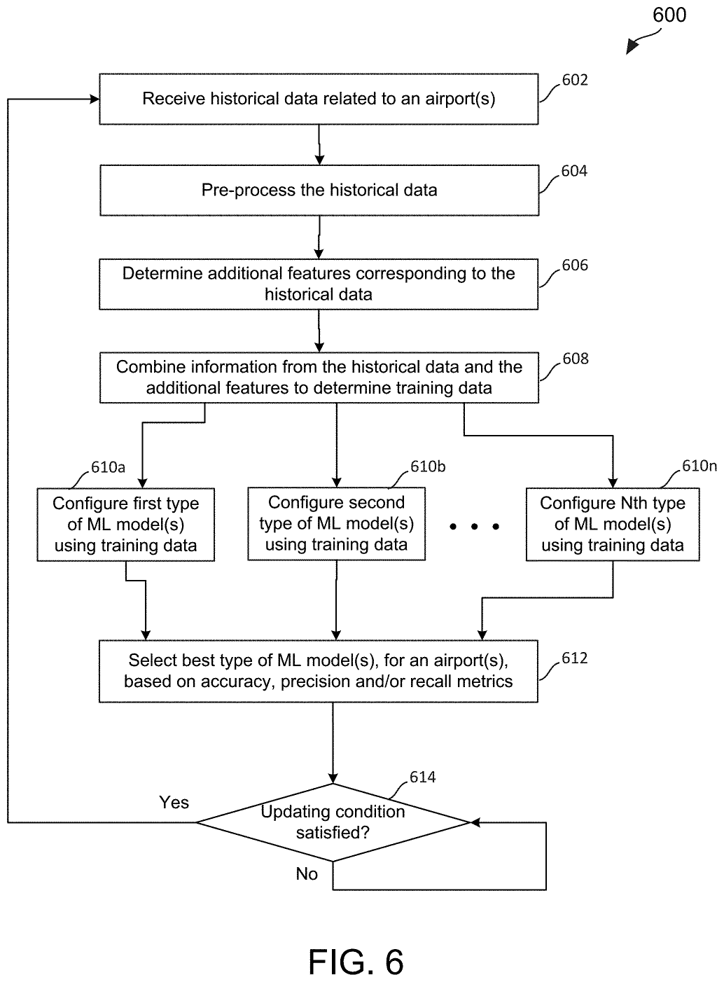

FIG. 6 illustrates an example routine 600 that may be performed by the computing system(s) 110 during training operations to train one or more ML models 112 for predicting a travel delay. In some embodiments, training operations may involve training of multiple different types of ML models, and selecting one of the type of ML models for runtime/inference operations, where the selection may be based on the ML models performance with respect to the training data. In some cases, a particular type of ML model may be better suited to learn from certain data patterns and generate more accurate predictions. In some embodiments, the computing system(s) 110 may use a first type of ML model for generating delay predictions for flights departing from/arriving at a first airport, may use another/second type of ML model for generating delay predictions for flights departing from/arriving at a second airport, and so on. In other embodiments, the computing system(s) 110 may use a first type of ML model for generating delay predictions for flights of a first airline, may use another/second type of ML model for generating delay predictions for flights of a second airline, and so on.

In some embodiments, the ML model(s) 112 may be updated (e.g., retrained, fine-tuned, etc.) on a periodic basis (e.g., monthly basis, quarterly basis, etc.) using recent historical data. During updating, a different type of ML model may be selected for use. For instance, the ML model selected for use may be selected based on the ML model being better suited to learn from data patterns in the recent historical data. For example, a first type of ML model may be selected for runtime operations based on training using data of a first time period, and a second type of ML model may be selected for runtime operations based on training using data of a second time period.

At step 602 of the routine 600, the computing system(s) 110 may receive historical data related to a particular airport or a group of airports. The group of airports may include airports of similar sizes (e.g., area, number of gates, number of terminals, average number of daily flights, average number of passengers served, etc.), airports in a similar or a same geographic region, airports in locations that experience similar weather, etc. The historical data may include one or more of on-time performance data for past flights (e.g., flights with their on-time departure/on-time arrival indication), past weather information, aircraft maintenance data for aircrafts used for past flights, and past event data. In other embodiments, the historical data may include other information, such as pilot communications during past flights, last leg delay information for past flights, etc. The historical data may be provided by one or more systems, such as the airport system(s) 120, the airline system(s) 130, the weather system(s) 450, and the like.

At step 604 of the routine 600, the computing system(s) 110 may pre-process the historical data prior to using the data for training an ML model. As part of pre-processing, the computing system(s) 110 may remove certain information from the historical data that may not be needed for training purposes. For example, after pre-processing, only data related to airports, departure and arrival schedules, tail/aircraft number, flight number, flight date, operating airline, distance and airtime may remain. In some embodiments, empty data fields for canceled flights, for example, may also be removed.

At step 606 of the routine 600, the computing system(s) 110 may determine additional features corresponding to the historical data. Such additional features may include, but are not limited to, determining which flights were delayed (or cancelled), based on the on-time performance data, and determining a delayed flag or indicator for the corresponding flights. Another example of the additional features may be determining flights that departed on a weekend or a long/holiday weekend, and determining a weekend flag or other indicator for the corresponding flights. Another example of the additional features may be determining a time of day the flight departed/arrived (e.g., morning, afternoon, evening, night, etc.), and determining a time-of-day flag or other indicator for the corresponding flights. In some embodiments, other additional features may also be determined, for example, speech patterns or prosody information from pilot communications data, aircraft malfunction function flags or indicators, etc.

In some embodiments, determining the additional features may involve one or more of determining whether the previous flight leg was delayed; determining the number of times the flight number departed/arrived late in the past week; determining the number of times the flight number departed/arrived late in the past month; determining the number of times the aircraft (using the tail number) departed/arrived late in the past week; determining the number of times the aircraft (using the tail number) departed/arrived late in the past month; the on-time departure/arrival percentage of the airport; the on-time departure/arrival of the airline; the flight date being a holiday, a day before the holiday or the day after the holiday; and the week of the year (e.g., second week, twentieth week, etc.). Indicators of the foregoing may be associated with the individual flights.

At step 608 of the routine 600, the computing system(s) 110 may combine information from the historical data and the additional features to determine training data. In some embodiments, the determined flags or other indicators, along with the pre-processed historical data, may be included in the training data used to train ML models for predicting a travel delay. Additionally, the computing system(s) 110 may align the past weather information (e.g., hourly weather information), the past event data and the past aircraft maintenance data with the flight data, so that individual flights are associated with corresponding weather information, event information and/or aircraft maintenance information. In this manner, the training data may include information related to delayed flights, on-time flights, flight number, flight departing airport, departure time, flight arrival airport, arrival time, weekend flight, part-of-day departure, part-of-day arrival, airline identifier, weather information, event information, aircraft maintenance information, etc. Other information may also be included in the training data. After combining (e.g., joining or merging) the information, the computing system(s) 110 may apply pre-processing steps, such as scaling, transformation, etc.

At step 610 of the routine 600, the computing system(s) 110 may configure different types of ML model(s) using the training data. For example, at step 610a, the computing system(s) 110 may configure a first type of ML model(s) using the training data, at a step 610b, the computing system(s) 110 may configure a second type of ML model(s) using the training data, and at a step 610n, the computing system(s) 110 may configure a Nth type of ML model(s) using the training data. In some embodiments, the different types of ML model(s) may be configured in parallel. Examples of the different types of ML models include a Gradient Boosting model, a Deep Neural Network model, a Cat Boost model, etc. In some embodiments, the ML models may be pre-trained, and the training data may be used to fine-tune the models. The performance of a configured ML model(s) may be evaluated using a test dataset, which may be derived from the combined data determined in the step 608. For example, the combined data may be divided into the training data and a test dataset.

In some embodiments, configuring the ML models may involve performing hyper parameter tuning using a grid search mechanism for selecting different values for a hyper parameter(s) based on the performance of the model during a prior training cycle. A different parameter grid may be used for the different types of ML model(s).

At step 612 of the routine 600, the computing system(s) 110 may select the best type of ML model(s) for an airport (or group of airports) based on one or more accuracy, precision and/or recall metrics. The selected type of ML model(s) may be included in the delay prediction engine 410 as the ML model(s) 112. The selected type of ML model(s) may be associated with a particular airport or group of airports. During runtime operations, one or more ML model(s) may be selected from a plurality of ML models based on which airport the user's scheduled flight is departing from and/or arriving to.

Accuracy metrics may generally describe how the model performs across all classes. The accuracy metrics may be calculated as the ratio between the number of correct predictions to the total number of predictions. Precision metrics may be calculated as the ratio between the number of positive samples correctly classified to the total number of samples classified as positive (either correctly or incorrectly). The precision metrics may measure the model's accuracy in classifying a sample as positive. Recall metrics may be calculated as the ratio between the number of positive samples correctly classified as positive to the total number of positive samples. The recall metrics may measure the model's ability to detect positive samples. The higher the recall, the more positive samples are detected. The type of ML model(s) that satisfy certain threshold metrics may be selected as the ML model(s) 112 for runtime operations. In some implementations, the threshold metrics may be defined by a developer or system administrator.

Selecting the best type of ML model(s) to use to estimate a travel delay for a particular airport and/or travel scenario may involve determining first model performance data (e.g., accuracy, precision and/or recall metrics such as recall rate) corresponding to the first type of ML model(s), determining second model performance data corresponding to the second type of ML model(s), and selecting the first type of ML model, for example, based on a comparison of the first model performance data and the second model performance data, where the first model performance data may be better than the second model performance data.

The selected type of ML model(s) may be used in runtime operations for a period of time. In some embodiments, the ML model(s) may be updated on a periodic basis. At step 614 of the routine 600, the computing system(s) 110 may determine whether an updating condition (for the ML model(s) 112) is satisfied. If the condition is satisfied, then the routine 600 is performed again, starting at the step 602, to train multiple types of ML models using historical data corresponding to a different time period (e.g., a more recent time period). For example, in the prior iteration of the routine 600, the historical data/training data may correspond to a first time period (e.g., January to March), and in the subsequent iteration of the routine 600, the historical data/training data may correspond to a second time period (e.g., April to June).

When updating, a type of ML model(s) different from the prior type of ML model(s) used may be selected based on changes in data patterns and/or which type of ML model(s) is better suited for example, for a particular airport or travel scenario. For example, a first type of ML model(s) may be selected for runtime operations during the prior iteration of the routine 600, and a second type of ML model(s) may be selected for runtime operations during the subsequent iteration of the routine 600.

The computing system(s) 110 may check the updating condition again on a periodic basis, until the updating condition is satisfied, which may trigger performance of the routine 600. In example embodiments, the updating condition may be elapse of a certain duration of time, for example, a week, a month, a quarter, etc. In other example embodiments, the updating condition may be that runtime performance (e.g., accuracy, precision and/or recall) of the ML model(s) falls below a certain threshold, which may occur based on changes in runtime data patterns. In some implementations, the updating condition may be defined by a user, a developer or a system administrator.

The routine 600 may be performed using different/second historical data related to a different/second airport(s) to determine the best type of ML model(s) for predicting travel delays for the second airport(s).

A routine similar to the routine 600 may be used to configure different types of ML model(s) for a particular airline or group of airlines, and then select the best type of ML model(s) for the particular airline(s).

In this manner, the technology described in the present disclosure provides a system for predicting a travel delay based on historical information, and determining alternate travel options that are feasible for the user given the user's current location. The system may predict likely travel delays prior to an actual delay occurring (e.g., prior to the airline and/or airport alerting the user of the delay; prior to the scheduled flight being actually delayed, etc.), which may provide the user with sufficient time to make alternate travel arrangements. The accuracy of the travel delay prediction may be improved by selection of a particular type of predictive ML model that is better suited for particular data patterns, and/or updating the type of ML model used based on changes in recent data patterns.

Although the techniques and examples described herein relate to predicting a delay with respect to air travel, similar techniques may be used to predict delays with respect to other modes of travel, such as bus, train, boat, car, etc., and provide alternate travel options that are feasible for the user. Additionally, it should be appreciated that alternate travel options need not be restricted to the same mode of travel as the user's originally scheduled travel. For instance, alternate travel options for a delayed flight may include alternate flights, alternate bus travel, alternate train travel, alternate car travel (e.g., via a ride sharing service, rental car company, or private transportation company such as taxi or car service, etc.).

The system of the present disclosure may provide further features that may enhance a user's travel experience and use of time. Additional features may include, but are not limited to, user authentication techniques (e.g. two-factor authentication) to enable the computing system(s) 110 access to the device 202 and user account storage. Another feature may be a single sign-on mechanism that provides access to more than one of the user's travel accounts (e.g., different airline rewards programs, payment information, etc.). Another feature may be different ways for communicating information (e.g., flight updates, alternate flights, hotel recommendations, etc.) with the user, such as push/app notifications, email, text messages, etc.

In some embodiments, the system may use user-specific information to determine whether it is feasible for the user to make a flight. For example, the system may use the user's historical driving and/or walking time to determine how long it may take the user to navigate to an airport gate. In some embodiments, the system may inform the user of other types of delays (e.g., traffic delays, user is delayed in leaving current location, lines are longer than predicted, etc.) that may cause the user to be delayed in reaching an airport gate.

In some embodiments, the system may provide “boarding time” notifications to the user. Such notifications may be provided based on the user's current location. For example, if the user is already at the gate, then a boarding time notification may not be provided. As another example, if the user is not near the gate, then a board time notification may be provided. In some embodiments, the system may enable the user to access a boarding pass via the user interface 104 for a flight that the user is about to board.

What is claimed is:

1. A method for facilitating air travel, the method comprising:
determining, using first user travel data corresponding to a scheduled flight for a user, a departure delay for the scheduled flight;
determining, based at least in part, on the departure delay for the scheduled flight, an alternate flight for the user, the determination being based, at least in part, on one or more of user location data, departure time information for the alternate flight, seat availability for the alternate flight, or an estimated time needed to reach an airport gate from which the alternate flight departs; and
presenting, using a user interface, information corresponding to the alternate flight and a selectable user interface element to enable the user to book the alternate flight.

2. The method of claim 1, further comprising:
receiving the first user travel data including at least one of a flight number, departure time information or a first departing airport; and
processing, using a first machine learning model, at least the first user travel data to predict the departure delay for the scheduled flight, the first machine learning model being trained using at least one of historical information corresponding to the flight number or historical information corresponding to the first departing airport.

3. The method of claim 2, further comprising, after receiving the first user travel data:
receiving historical data corresponding to a plurality of airports, the historical data including at least one of departure delay information for respective airports or arrival delay information for respective airports;
training the first machine learning model using the historical data;
training a second machine learning model, different than the first machine learning model, using the historical data;
determining first model performance data corresponding to the first machine learning model;
determining second model performance data corresponding to the second machine learning model; and
selecting, based at least in part on a comparison of the first model performance data and the second model performance data, the first machine learning model to process subsequent user travel data.

4. The method of claim 2, further comprising:
receiving first historical data corresponding to the first departing airport, the first historical data including at least one of departure delay information relating to a plurality of flights departing from the departing airport or arrival delay information relating to a plurality of flights arriving at the first departing airport;
receiving historical weather data corresponding to a location of the first departing airport;
training the first machine learning model using at least the first historical data and the historical weather data;
training a second machine learning model, different than the first machine learning model, using at least the first historical data and the historical weather data;
determining first model performance data corresponding to the first machine learning model;
determining second model performance data corresponding to the second machine learning model; and
selecting, based at least in part on a comparison of the first model performance data and the second model performance data, the first machine learning model to process subsequent user travel data.

5. The method of claim 2, further comprising:
receiving second user travel data corresponding to a flight departing from a second departing airport different from the first departing airport; and
selecting a second machine learning model to predict a departure delay for the flight departing from the second departing airport, the selection being based on the second machine learning model being configured for the second departing airport.

6. The method of claim 2, further comprising:
determining an aircraft for the scheduled flight;
determining one or more previous flights the aircraft is to complete, within a time period, before the flight;
determining delay information for the one or more previous flights; and
processing the delay information and the first user travel data using the first machine learning model to predict the departure delay.

7. The method of claim 1, further comprising:
in response to predicting the departure delay, presenting, using the user interface of the application, an indication that the scheduled flight is delayed; and
presenting, using the user interface, a representation of one or more features causing the departure delay.

8. The method of claim 7, further comprising:
receiving airport data corresponding to a first departing airport for the scheduled flight, the airport data including at least one of airport traffic information or flight delay information;
receiving weather data corresponding to the departure time information and a location of the first departing airport, the weather data including past hourly weather information and predicted future hourly weather information;
receiving airline data corresponding to an airline providing the scheduled flight, the airline data including at least one of airline on-time departure information, airline on-time arrival information or crew schedule information;
receiving event data corresponding to the departure time information, the event data including at least one of information related to one or more events occurring in the location of the first departing airport or national holiday information;
processing, using a first machine learning model, the airport data, the weather data, the airline data, and the event data to generate model output data used to predict the departure delay; and
processing, using a second machine learning model configured to identify a cause for the departure delay, the model output data to determine the one or more features causing the departure delay, wherein the one or more features include one or more of: the airport data, the weather data, the airline data or the event data.

9. The method of claim 1, further comprising:
receiving the user location data representing a current location of the user;
determining, based on the user location data, one or more pre-boarding activities to be completed by the user prior to boarding the alternate flight, wherein the one or more pre-boarding activities include one or more of: travel to a departing airport of the alternate flight, parking at a departing airport of the alternate flight, flight check-in, baggage check-in, airport security or travel to the airport gate; and
based in part on the determined pre-boarding activities, determining the estimated time needed to reach the airport gate for the alternate flight.

10. The method of claim 9, wherein determining the estimated time further comprises:
receiving airport context data corresponding to the departing airport of the alternate flight and the departure time information for the alternate flight, wherein the airport context data includes at least one of an airport layout, traffic information for parking at the departing airport of the alternate flight, traffic information for curbside drop-off at the departing airport of the alternate flight, length of line at a check-in counter for an airline of the alternate flight, length of line at a baggage drop of the airline of the alternate flight, or an estimated length of time for airport security at the departing airport of the alternate flight; and
determining the estimated time using the airport context data.

11. The method of claim 2, further comprising:
receiving aircraft maintenance data for an aircraft for the scheduled flight, the aircraft maintenance data including at least one of a date of recent maintenance work performed on the aircraft or previous equipment failure for the aircraft; and
processing the aircraft maintenance data using the first machine learning model to predict the departure delay.

12. The method of claim 2, further comprising:
receiving pilot communication data corresponding to an aircraft for the scheduled flight, the pilot communication data representing one or more communications between a pilot of the aircraft and an airport traffic control tower, wherein the one or more communications occurred during a previous flight of the aircraft; and
processing the pilot communication data using the first machine learning model to predict the departure delay.

13. The method of claim 1, further comprising:
predicting the departure delay before an airline of the scheduled flight identifies an actual delay of the scheduled flight; and
in response to predicting the departure delay, presenting, using the user interface of the application, an indication that the scheduled flight is likely to be delayed.

14. A system, comprising:
at least one processor; and
at least one computer-readable medium encoded with instructions which, when executed by the at least one processor, cause the system to:
determine, using first user travel data corresponding to a scheduled flight for a user, a departure delay for the scheduled flight;
determine, based at least in part, on the departure delay for the scheduled flight, an alternate flight for the user, the determination being based, at least in part, on one or more of user location data, departure time information for the alternate flight, seat availability for the alternate flight, or an estimated time needed to reach an airport gate from which the alternate flight departs; and
present, using a user interface, information corresponding to the alternate flight and a selectable user interface element to enable the user to book the alternate flight.

15. The system of claim 14, wherein the computer-readable medium is encoded with additional instructions which, when executed by the at least one processor, further cause the system to:
receive the first user travel data including at least one of a flight number, departure time information or a first departing airport; and
process, using a first machine learning model, at least the first user travel data to predict the departure delay for the scheduled flight, the first machine learning model being trained using at least one of historical information corresponding to the flight number or historical information corresponding to the first departing airport.

16. The system of claim 15, wherein the computer-readable medium is encoded with additional instructions which, when executed by the at least one processor, further cause the system to:
receive historical data corresponding to a plurality of airports, the historical data including at least one of departure delay information for respective airports or arrival delay information for respective airports;
train the first machine learning model using the historical data;
train a second machine learning model, different than the first machine learning model, using the historical data;
determine first model performance data corresponding to the first machine learning model;
determine second model performance data corresponding to the second machine learning model; and
select, based at least in part on a comparison of the first model performance data and the second model performance data, the first machine learning model to process subsequent user travel data.

17. The system of claim 15, wherein the computer-readable medium is encoded with additional instructions which, when executed by the at least one processor, further cause the system to:
receive first historical data corresponding to the first departing airport, the first historical data including at least one of departure delay information relating to a plurality of flights departing from the departing airport or arrival delay information relating to a plurality of flights arriving at the first departing airport;
receive historical weather data corresponding to a location of the first departing airport;
train the first machine learning model using at least the first historical data and the historical weather data;
train a second machine learning model, different than the first machine learning model, using at least the first historical data and the historical weather data;
determine first model performance data corresponding to the first machine learning model;
determine second model performance data corresponding to the second machine learning model; and
select, based at least in part on a comparison of the first model performance data and the second model performance data, the first machine learning model to process subsequent user travel data.

18. The system of claim 15, wherein the computer-readable medium is encoded with additional instructions which, when executed by the at least one processor, further cause the system to:
receive second user travel data corresponding to a flight departing from a second departing airport different from the first departing airport; and
select a second machine learning model to predict a departure delay for the flight departing from the second departing airport, the selection being based on the second machine learning model being configured for the second departing airport.

19. The system of claim 14, wherein the computer-readable medium is encoded with additional instructions which, when executed by the at least one processor, further cause the system to:
in response to predicting the departure delay, present, using the user interface of the application, an indication that the scheduled flight is delayed; and
present, using the user interface, a representation of one or more features causing the departure delay.

20. At least one non-transitory computer-readable medium encoded with instructions which, when executed by at least one processor of a computing system, cause the computing system to:
determine, using first user travel data corresponding to a scheduled flight for a user, a departure delay for the scheduled flight;
determine, based at least in part, on the departure delay for the scheduled flight, an alternate flight for the user, the determination being based, at least in part, on one or more of user location data, departure time information for the alternate flight, seat availability for the alternate flight, or an estimated time needed to reach an airport gate from which the alternate flight departs; and
present, using a user interface, information corresponding to the alternate flight and a selectable user interface element to enable the user to book the alternate flight.
